(19) United States
(12) Patent Application Publication
(10) Pub. No.: US 2023/0250011 A1
(43) Pub. Date: Aug. 10, 2023

(54) GLASS

(71) Applicant: AGC Inc., Tokyo (JP)

(72) Inventors: Akira SHIBATA, Tokyo (JP); Kenji KITAOKA, Tokyo (JP)

(73) Assignee: AGC Inc., Tokyo (JP)

(21) Appl. No.: 18/120,931

(22) Filed: Mar. 13, 2023

Related U.S. Application Data
(63) Continuation of application No. PCT/JP2021/027999, filed on Jul. 29, 2021.

(30) Foreign Application Priority Data
Sep. 18, 2020 (JP) 2020-157685

(51) Int. Cl. C03C 3/21; C03C 3/12

(52) U.S. Cl. CPC C03C 3/21; C03C 3/122

(57) ABSTRACT

To provide glass having a high refractive index and a high transmittance. Glass (10) contains at least one component selected from the group consisting of TeO₂, TiO₂, WO₃, Nb₂O₅, and Bi₂O₃, where Bi₂O₃ > 11.2% is satisfied, in mole percentage on an oxide basis, in which 3.78 ≤ Nb₂O₅/ (TeO₂ + TiO₂ + WO₃ + Nb₂O₅ + Bi₂O₃) × 100 ≤ 19.2 is satisfied, and a total content of Fe, Cr, and Ni is smaller than 4 ppm by mass.

### CROSS REFERENCE TO RELATED APPLICATION(S)

This application is a continuation of International Application No. PCT/JP2021/027999, filed on Jul. 29, 2021,which claims priority to Japanese Patent Application No. 2020-157685, filed on Sep. 18, 2020, the entire contents of which are incorporated herein by reference.

### FIELD

The present invention relates to glass. Background

In recent years, there is a demand for glass having a high refractive index and a high transmittance. Particularly, for example, in wearable devices such as a head-mounted display that implements Augmented Reality (AR), Virtual Reality (VR), Mixed Reality (MR), and the like, a light guide plate is required to have a high refractive index property and a high transmittance property with respect to visible light. For example, Patent Literature 1 discloses optical glass having a high refractive index and a high transmittance.

### CITATION LIST

### Patent Literature

Patent Literature 1: Japanese Patent No. 5682171 Summary

### Technical Problem

However, there is room for improvement in a transmittance property of the optical glass disclosed in Patent Literature 1. Thus, there is a demand for glass having a high refractive index and a high transmittance.

The present invention is made in view of such a situation, and an object thereof is to provide glass having a high refractive index and a high transmittance.

### Solution to Problem

A glass of the present disclosure contains: at least one component selected from the group consisting of TeO₂, TiO₂, WO₃, Nb₂O₅, and Bi₂O₃, where Bi₂O₃ > 11.2% is satisfied, in mole percentage on an oxide basis, wherein 3.78 ≤ Nb₂O₅/ (TeO₂ + TiO₂ + WO₃ + Nb₂O₅ + Bi₂O₃) × 100 ≤ 19.2 is satisfied, and a total content of Fe, Cr, and Ni is smaller than 4 ppm by mass.

### Advantageous Effects of Invention

According to the present invention, it is possible to provide glass having a high refractive index and a high transmittance.

### BRIEF DESCRIPTION OF DRAWINGS

FIG. 1 is a schematic diagram of glass according to an embodiment.

FIG. 2 is a cross-sectional view assuming that the glass according to the present embodiment is a glass plate.

### DESCRIPTION OF EMBODIMENTS

The following describes a preferred embodiment of the present invention in detail with reference to the attached drawings. The present invention is not limited to the embodiment, and in a case in which there are a plurality of embodiments, the embodiments may be combined with each other. Numerical values encompass rounded numerical values.

### (Glass)

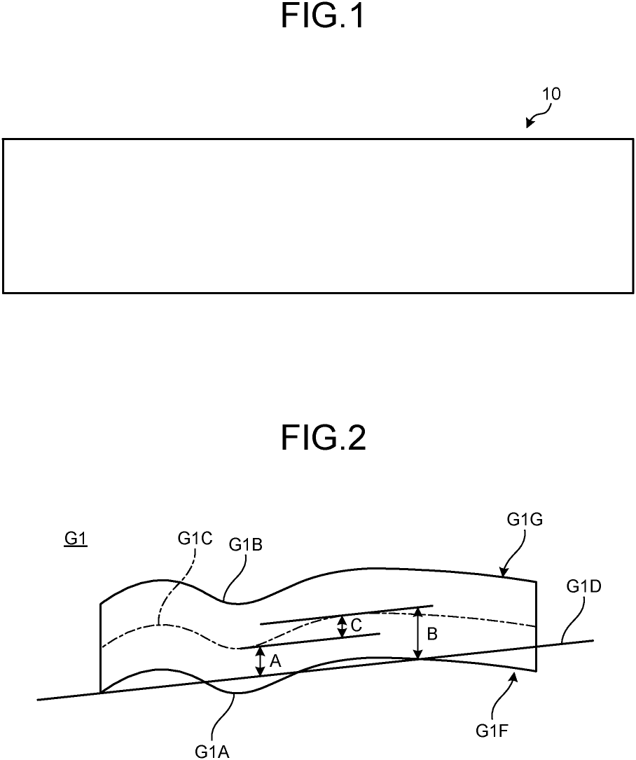

FIG. 1 is a schematic diagram of glass according to the present embodiment. As illustrated in FIG. 1, glass 10 according to the present embodiment is a glass plate having a plate shape. However, the shape of the glass 10 is not limited to the plate shape, but may be optional. In the present embodiment, the glass 10 is used as a light guide plate. More specifically, the glass 10 is used as a light guide plate for a head-mounted display. The head-mounted display is a display device (wearable device) mounted on a person’s head. However, a use of the glass 10 is optional. The glass 10 is not necessarily used as a light guide plate, and is not necessarily used for a head-mounted display.

### Glass Composition

The following describes composition of the glass 10.

### Bi₂O₃

In mole percentage on an oxide basis, a content of Bi₂O₃ of the glass 10 is larger than 11.2%, preferably larger than 15.0%, more preferably equal to or larger than 20.0%, and even more preferably equal to or larger than 25.0%. A lower limit value of Bi₂O₃ is larger than 11.2%, so that a high refractive index is preferably achieved. Additionally, in mole percentage on an oxide basis, the content of Bi₂O₃ of the glass 10 is preferably smaller than 45.0%, more preferably smaller than 40.0%, even more preferably smaller than 35.0%, and further more preferably smaller than 32.0%. An upper limit value of Bi₂O₃ is smaller than 45.0%, so that a high transmittance is preferably achieved. In this way, by causing the content of Bi₂O₃ to fall within this range, the glass 10 is enabled to have a high refractive index while maintaining a high transmittance with respect to visible light. Herein, the content indicates a mole percentage of a content of oxide assuming that a mole percentage of a total amount of the glass 10 is 100% in mole percentage on an oxide basis. That is, for example, “the content of Bi₂O₃ is larger than 11.2%” means that the content of Bi₂O₃ is larger than 11.2% assuming that the mole percentage of the total amount of the glass 10 is 100% in mole percentage on an oxide basis.

### Nb₂O₅

In mole percentage on an oxide basis, a content of Nb₂O₅ of the glass 10 is preferably larger than 2.0%, more preferably larger than 3.0%, even more preferably larger than 4.0%, and further more preferably larger than 5.0%. A lower limit value of Nb₂O₅ is larger than 2.0%, so that a high refractive index is preferably achieved. Additionally, in mole percentage on an oxide basis, the content of Nb₂O₅ of the glass 10 is preferably smaller than 15.0%, more preferably smaller than 10.0%, even more preferably smaller than 9.0%, and further more preferably smaller than 8.0%. An upper limit value of Nb₂O₅ is smaller than 15.0%, so that stability of the glass can be preferably maintained. In this way, by causing the content of Nb₂O₅ to fall within this range, the glass 10 is enabled to have a high refractive index while maintaining a high transmittance with respect to visible light.

### TeO₂

In mole percentage on an oxide basis, a content of TeO₂ of the glass 10 is preferably larger than 10.1%, more preferably larger than 20.3%, even more preferably larger than 23.0%, and further more preferably larger than 25.0%. A lower limit value of TeO₂ is larger than 10.1%, so that a high refractive index is preferably achieved. Additionally, in mole percentage on an oxide basis, the content of TeO₂ of the glass 10 is preferably smaller than 33.1%, more preferably smaller than 30.0%, even more preferably smaller than 29.0%, and further more preferably smaller than 28.0%. An upper limit value of TeO₂ is smaller than 33.1%, so that a high transmittance is preferably achieved. In this way, by causing the content of TeO₂ to fall within this range, the glass 10 is enabled to have a high refractive index while maintaining a high transmittance with respect to visible light.

### P₂O₅

The glass 10 preferably contains P₂O₅ as an essential component. If P₂O₅ is not contained therein, it is not impossible to obtain the glass, but the glass becomes unstable and manufacturability is deteriorated. Thus, in mole percentage on an oxide basis, a content of P₂O₅ of the glass 10 is preferably larger than 2.0%, more preferably larger than 4.0%, even more preferably larger than 6.0%, and further more preferably larger than 8.0%. A lower limit value of P₂O₅ is larger than 2.0%, so that stability of the glass can be preferably maintained. Additionally, in mole percentage on an oxide basis, the content of P₂O₅ of the glass 10 is preferably smaller than 18.0%, more preferably smaller than 16.0%, even more preferably smaller than 14.0%, and further more preferably smaller than 12.0%. An upper limit value of P₂O₅ is smaller than 18.0%, so that a high refractive index is preferably achieved. In this way, by causing the content of P₂O₅ to fall within this range, the glass 10 is enabled to have a high refractive index while maintaining a high transmittance with respect to visible light.

### B₂O₃

In mole percentage on an oxide basis, a content of B₂O₃ of the glass 10 is preferably larger than 12.0%, more preferably larger than 14.0%, and even more preferably larger than 16.0%. A lower limit value of B₂O₃ is larger than 12.0%, so that stability of the glass can be preferably maintained. Additionally, in mole percentage on an oxide basis, the content of B₂O₃ of the glass 10 is preferably smaller than 40.0%, more preferably smaller than 35.0%, and even more preferably smaller than 30.0%. An upper limit value of B₂O₃ is smaller than 40.0%, so that a high refractive index is preferably achieved. By causing the content of B₂O₃ to fall within this range, the glass 10 is enabled to maintain stability of the glass while maintaining a high transmittance with respect to visible light.

### TiO₂

In mole percentage on an oxide basis, a content of TiO₂ of the glass 10 is preferably smaller than 1.0%, more preferably smaller than 0.5%, and even more preferably smaller than 0.1%. TiO₂ is an optional component. An upper limit value of TiO₂ is smaller than 1.0%, so that a high transmittance is preferably achieved. More specifically, when TiO₂ is contained therein, a high refractive index is achieved but a transmittance is lowered. Thus, by causing the content of TiO₂ to fall within this range, the glass 10 is enabled to have a high refractive index while maintaining a high transmittance with respect to visible light.

### Ta₂O₅

In mole percentage on an oxide basis, a content of Ta₂O₅ of the glass 10 is preferably smaller than 1.0%, more preferably smaller than 0.5%, and even more preferably smaller than 0.1%. An upper limit value of Ta₂O₅ is smaller than 1.0%, so that cost can be preferably reduced while maintaining stability of the glass. More specifically, when Ta₂O₅ is contained therein, a high refractive index is achieved, but the glass becomes unstable and a devitrification property is deteriorated. Additionally, it is expensive, so that cost is increased. By causing the content of Ta₂O₅ to fall within this range, the glass 10 is enabled to have a high refractive index while maintaining a high transmittance with respect to visible light.

### Wo₃

In mole percentage on an oxide basis, a content of WO₃ of the glass 10 is preferably smaller than 1.0%, more preferably smaller than 0.5%, and even more preferably smaller than 0.1%. An upper limit value of WO₃ is smaller than 1.0%, so that a high transmittance is preferably achieved. Furthermore, when WO₃ is contained therein, a high refractive index is achieved but a transmittance is lowered, so that WO₃ is an optional component. By causing the content of WO₃ to fall within this range, the glass 10 is enabled to have a high refractive index while maintaining a high transmittance with respect to visible light.

### ZnO

In mole percentage on an oxide basis, a content of ZnO of the glass 10 is preferably larger than 1.0%, more preferably larger than 2.0%, and even more preferably larger than 3.0%. A lower limit value of ZnO is larger than 1.0%, so that stability of the glass can be preferably maintained. Additionally, in mole percentage on an oxide basis, the content of ZnO of the glass 10 is preferably smaller than 15.0%, more preferably smaller than 12.0%, and even more preferably smaller than 10.0%. An upper limit value of ZnO is smaller than 15.0%, so that a high refractive index is preferably achieved. In this way, by causing the content of ZnO to fall within this range, the glass 10 is enabled to maintain stability of the glass while maintaining a high refractive index with respect to visible light.

### TeO₂ + TiO₂ + WO₃ + Nb₂O₅ + Bi₂O₃

In mole percentage on an oxide basis, regarding the glass 10, (TeO₂ + TiO₂ + WO₃ + Nb₂O₅ + Bi₂O₃), that is, a total content of TeO₂, TiO₂, WO₃, Nb₂O₅, and Bi₂O₃ is preferably larger than 50.0%, more preferably larger than 55.0%, and even more preferably larger than 60.0%. A lower limit value of the total content thereof is larger than 50.0%, so that a high refractive index is preferably achieved. In mole percentage on an oxide basis, regarding the glass 10, the total content of TeO₂, TiO₂, WO₃, Nb₂O₅, and Bi₂O₃ is preferably smaller than 75.0%, more preferably smaller than 70.0%, and even more preferably smaller than 65.0%. An upper limit value of the total content thereof is smaller than 75.0%, so that a high transmittance is preferably achieved. In this way, by causing the total content of TeO₂, TiO₂, WO₃, Nb₂O₅, and Bi₂O₃ to fall within this range, the glass 10 is enabled to have a high refractive index while maintaining a high transmittance with respect to visible light. However, TiO₂ and WO₃ are not necessarily contained therein.

### Nb₂O₅/ (TeO₂ + TiO₂ + WO₃ + Nb₂O₅ + Bi₂O₃) × 100

The glass 10 contains at least one component selected from the group consisting of TeO₂, TiO₂, WO₃, Nb₂O₅, and Bi₂O₃, and preferably contains Nb₂O₅ and at least one component selected from the group consisting of TeO₂, TiO₂, WO₃, and Bi₂O₃. Regarding the glass 10, Nb₂O₅/ (TeO₂ + TiO₂ + WO₃ + Nb₂O₅ + Bi₂O₃) × 100 is preferably larger than 3.78, more preferably larger than 5.0, even more preferably larger than 7.0, and further more preferably larger than 10.0. A lower limit value of Nb₂O₅/ (TeO₂ + TiO₂ + WO₃ + Nb₂O₅ + Bi₂O₃) × 100 is larger than 3.78, so that a high refractive index is preferably achieved. Additionally, regarding the glass 10, Nb₂O₅/ (TeO₂ + TiO₂ + WO₃ + Nb₂O₅ + Bi₂O₃) × 100 is preferably smaller than 19.2, more preferably smaller than 15.0, even more preferably smaller than 14.0, and further more preferably smaller than 12.0. Nb₂O₅/ (TeO₂ + TiO₂ + WO₃ + Nb₂O₅ + Bi₂O₃) × 100 is smaller than 19.2, so that a high transmittance is preferably achieved. Nb₂O₅/ (TeO₂ + TiO₂ + WO₃ + Nb₂O₅ + Bi₂O₃) × 100 indicates a value obtained by multiplying 100 by a ratio of the content of Nb₂O₅ in mole percentage on an oxide basis to the total content of TeO₂, TiO₂, WO₃, Nb₂O₅, and Bi₂O₃ in mole percentage on an oxide basis. In this way, by causing Nb₂O₅/ (TeO₂ + TiO₂ + WO₃ + Nb₂O₅ + Bi₂O₃) × 100 to fall within this range, the glass 10 is enabled to have a high refractive index while maintaining a high transmittance with respect to visible light. However, TiO₂ and WO₃ are not necessarily contained therein.

### Bi₂O₃ + Nb₂O₅ + TeO₂ + P₂O₅ + B₂O₃ + TiO₂ + Ta₂O₅ + WO₃ + ZnO

Regarding the glass 10, (Bi₂O₃ + Nb₂O₅ + TeO₂ + P₂O₅ + B₂O₃ + TiO₂ + Ta₂O₅ + WO₃ + ZnO), that is, the total content of Bi₂O₃, Nb₂O₅, TeO₂, P₂O₅, B₂O₃, TiO₂, Ta₂O₅, WO₃, and ZnO, which are oxides described above, is preferably 100%. However, SiO₂ and Al₂O₃ eluted from a melting vessel such as a quartz crucible or an alumina crucible are allowed to be contained in the glass. Additionally, impurities that are inevitable in manufacture, that is, inevitable impurities are allowed to be contained therein. In this case, in mole percentage on an oxide basis, the total content of SiO₂ and Al₂O₃ of the glass 10 is preferably equal to or smaller than 3.0%, more preferably equal to or smaller than 2.0%, and even more preferably equal to or smaller than 1.0%. That is, it is preferable that the glass 10 should not contain components other than Bi₂O₃, Nb₂O₅, TeO₂, P₂O₅, B₂O₃, TiO₂, Ta₂O₅, WO₃, and ZnO except inevitable impurities. Due to such composition of the glass 10, a high refractive index and a high transmittance with respect to visible light can be achieved. However, TiO₂ and WO₃ are not necessarily contained therein.

### (Contents of Fe, Cr, and Ni)

Regarding the glass 10, in mass ratio, a total content of Fe, Cr, and Ni is smaller than 4 ppm, preferably equal to or smaller than 3 ppm, more preferably equal to or smaller than 2 ppm, and even more preferably equal to or smaller than 1 ppm with respect to the entire glass 10. Herein, Fe, Cr, and Ni do not indicate only single metals of Fe, Cr, and Ni contained in the glass 10, but may include single metals and a compound of Fe, Cr, and Ni. That is, it can be said that the total content of Fe, Cr, and Ni includes contents of single metals of Fe, Cr, and Ni and contents of ions of Fe, Cr, and Ni in a compound. By causing the total content of Fe, Cr, and Ni as coloring transition metals to fall within this range, a transmittance of the glass 10 with respect to visible light can be prevented from being lowered, and the glass 10 is enabled to have a high transmittance with respect to visible light. The total content of Fe, Cr, and Ni can be measured by ICP mass spectrometry. As a measuring instrument, for example, Agilent 8800 manufactured by Agilent Technologies can be used.

Regarding the glass 10, in mass ratio, a total content of Fe, Cr, Ni, Cu, Mn, Co, and V is preferably smaller than 4 ppm, more preferably equal to or smaller than 3 ppm, even more preferably equal to or smaller than 2 ppm, and further more preferably equal to or smaller than 1 ppm with respect to the entire glass 10. Similarly to Fe, Cr, and Ni described above, Fe, Cr, Ni, Cu, Mn, Co, and V herein do not indicate only single metals of Fe, Cr, Ni, Cu, Mn, Co, and V contained in the glass 10, but may also include single metals and a compound of Fe, Cr, Ni, Cu, Mn, Co, and V. That is, it can be said that the total content of Fe, Cr, Ni, Cu, Mn, Co, and V includes contents of single metals of Fe, Cr, Ni, Cu, Mn, Co, and V and contents of ions of Fe, Cr, Ni, Cu, Mn, Co, and V in a compound. By causing the total content of the components described above as coloring transition metals to fall within this range, a transmittance of the glass 10 with respect to visible light can be prevented from being lowered, and the glass 10 is enabled to have a high transmittance with respect to visible light. The total content of the components described above can be measured by ICP mass spectrometry.

### (Content of Pb)

Regarding the glass 10, in mass ratio, the total content of Pb is preferably smaller than 1000 ppm, more preferably equal to or smaller than 100 ppm, and even more preferably equal to or smaller than 10 ppm with respect to the entire glass 10. That is, it is preferable that the glass 10 should not substantially contain Pb. Similarly to Fe, Cr, and Ni described above, Pb herein does not indicate only a single metal of Pb contained in the glass 10, but may also include a single metal and a compound of Pb. That is, it can be said that the content of Pb includes a content of a single metal of Pb and a content of ions of Pb in a compound. The content of Pb can be measured by ICP mass spectrometry.

### Refractive Index N_{d}

Regarding the glass 10 having the composition described above, a refractive index n_{d} is preferably equal to or larger than 2.00, more preferably equal to or larger than 2.05, and even more preferably equal to or larger than 2.10. By causing the refractive index n_{d} to fall within this range, a high refractive index with respect to visible light can be achieved. The refractive index n_{d} indicates a refractive index at a d line of helium (wavelength of 587.6 nm). The refractive index n_{d} can be measured by a V-block method.

### Wavelength Λ₇₀

Herein, a wavelength indicating an external transmittance of 70% with a plate thickness (thickness) of 10 mm is assumed to be a wavelength λ₇₀. That is, the wavelength λ₇₀ indicates a wavelength of light with which the external transmittance becomes 70% with respect to a sample having a thickness of 10 mm. The wavelength λ₇₀ of the glass 10 with the plate thickness (thickness) of 10 mm is preferably smaller than 450 nm, more preferably equal to or smaller than 445 nm, even more preferably equal to or smaller than 440 nm, and further more preferably equal to or smaller than 435 nm. By causing the wavelength λ₇₀ to fall within this range, a high transmittance with respect to visible light can be achieved. The external transmittance for calculating the wavelength λ₇₀ can be measured by using a spectrophotometer (U-4100 manufactured by Hitachi High-Tech Corporation) for a sample both surfaces of which are mirror-polished to have a plate thickness of 10 mm.

### Transmittance of Light

Regarding the glass 10, an internal transmittance of light at a wavelength of 450 nm with a plate thickness (thickness) of 10 mm is preferably equal to or larger than 91.5%, preferably equal to or larger than 93.0%, and more preferably equal to or larger than 95.0%. By causing the internal transmittance of light at a wavelength of 450 nm to fall within this range, a high transmittance with respect to visible light can be achieved. The internal transmittance of the glass having a thickness of 10 mm can be obtained from measurement values of two types of external transmittance with different plate thicknesses and the following expression (1). The external transmittance means a transmittance including a surface reflection loss. In the expression (1), X is the internal transmittance of the glass having a thickness of 10 mm, T1 and T2 are external transmittance, and Δd is a difference between thicknesses of samples.

$$log \text{} X = - \frac{log T 1 - log T 2}{Δ d} \times 10$$

### Form of Glass

The glass 10 according to the present embodiment is preferably optical glass, and is preferably a glass plate having a thickness equal to or larger than 0.01 mm and equal to or smaller than 2.0 mm. If the thickness is equal to or larger than 0.01 mm, the glass 10 can be prevented from being damaged at the time of handling or processing. Additionally, it is possible to suppress deflection of the glass 10 caused by self weight. The thickness is more preferably equal to or larger than 0.1 mm, even more preferably equal to or larger than 0.2 mm, and further more preferably equal to or larger than 0.3 mm. On the other hand, if the thickness is equal to or smaller than 2.0 mm, a weight of an optical element using the glass 10 can be reduced. The thickness is more preferably equal to or smaller than 1.5 mm, even more preferably equal to or smaller than 1.0 mm, and further more preferably equal to or smaller than 0.8 mm.

In a case in which the glass 10 according to the present embodiment is a glass plate, an area of a main surface is preferably equal to or larger than 8 cm². If the area is equal to or larger than 8 cm², a large number of optical elements can be disposed, and productivity is improved. The area is more preferably equal to or larger than 30 cm², even more preferably equal to or larger than 170 cm², further more preferably equal to or larger than 300 cm², and particularly preferably equal to or larger than 1000 cm². On the other hand, if the area is equal to or smaller than 6500 cm², the glass plate can be easily handled, so that the glass plate can be prevented from being damaged at the time of handling or processing. The area is more preferably equal to or smaller than 4500 cm², even more preferably equal to or smaller than 4000 cm², further more preferably equal to or smaller than 3000 cm², and particularly preferably equal to or smaller than 2000 cm².

In a case in which the glass 10 according to the present embodiment is a glass plate, a local thickness variation (LTV) of a main surface of 25 cm² is preferably equal to or smaller than 2 µm. With flatness falling within this range, a nanostructure having a desired shape can be formed on the main surface using an imprint technique and the like, and a desired light guiding characteristic can be obtained. Particularly, a light guide body can prevent a ghost phenomenon and distortion from being caused due to a difference in an optical path length. This LTV is more preferably equal to or smaller than 1.5 µm, even more preferably equal to or smaller than 1.0 µm, and particularly preferably equal to or smaller than 0.5 µm.

Assuming that the glass 10 according to the present embodiment is a circular glass plate having a diameter of 8 inches, warpage is preferably equal to or smaller than 50 µm. If the warpage of the glass 10 is equal to or smaller than 50 µm, a nanostructure having a desired shape can be formed on the main surface using an imprint technique and the like, and a desired light guiding characteristic can be obtained. In a case of trying to obtain a plurality of light guide bodies, light guide bodies having stable quality can be obtained. The warpage of the glass 10 is more preferably equal to or smaller than 40 µm, even more preferably equal to or smaller than 30 µm, and particularly preferably equal to or smaller than 20 µm.

Assuming that the glass 10 according to the present embodiment is a circular glass plate having a diameter of 6 inches, the warpage is preferably equal to or smaller than 30 µm. If the warpage of the glass 10 is equal to or smaller than 30 µm, a nanostructure having a desired shape can be formed on the main surface using an imprint technique and the like, and a desired light guiding characteristic can be obtained. In a case of trying to obtain a plurality of light guide bodies, light guide bodies having stable quality can be obtained. The warpage of the glass 10 is more preferably equal to or smaller than 20 µm, even more preferably equal to or smaller than 15 µm, and particularly preferably equal to or smaller than 10 µm.

Assuming that the glass 10 according to the present embodiment is a square glass plate the sides of which are each 6 inches, the warpage is preferably equal to or smaller than 100 µm. If the warpage of the glass 10 is equal to or smaller than 100 µm, a nanostructure having a desired shape can be formed on the main surface using an imprint technique and the like, and a desired light guiding characteristic can be obtained. In a case of trying to obtain a plurality of light guide bodies, light guide bodies having stable quality can be obtained. The warpage of the glass 10 is more preferably equal to or smaller than 70 µm, even more preferably equal to or smaller than 50 µm, further more preferably equal to or smaller than 35 µm, and particularly preferably equal to or smaller than 20 µm.

FIG. 2 is a cross-sectional view assuming that the glass according to the present embodiment is a glass plate. The “warpage” is, assuming that the glass 10 according to the present embodiment is a glass plate G1, a difference C between a maximum value B and a minimum value A of a distance in a vertical direction between a reference line G1D of the glass plate G1 and a center line G1C of the glass plate G1 at an optional cross section that passes through the center of a main surface G1F of the glass plate G1 and is orthogonal to the main surface G1F of the glass plate G1.

A line of intersection of the optional cross section and the main surface G1F of the glass plate G1 orthogonal to each other is assumed to be a base line G1A. A line of intersection of the optional cross section and another main surface G1G of the glass plate G1 orthogonal to each other is assumed to be an upper line G1B. Herein, the center line G1C is a line connecting center points in a plate thickness direction of the glass plate G1. The center line G1C is calculated by obtaining a middle point with respect to a direction of laser irradiation (described later) between the base line G1A and the upper line G1B.

The reference line G1D is obtained as follows. First, the base line G1A is calculated using a measuring method of canceling influence of self weight. A straight line is obtained from the base line G1A by a least square method. The obtained straight line is the reference line G1D. As the measuring method of canceling influence of self weight, a well-known method is used.

For example, the main surface G1F of the glass plate G1 is supported at three points, the glass plate G1 is irradiated with a laser beam by a laser displacement gauge, and heights of the main surface G1F and the other main surface G1G of the glass plate G1 from an optional reference surface are measured.

Next, the glass plate G1 is inverted, the other main surface G1G is supported at three points opposed to the three points at which the one main surface G1F is supported, and heights of the main surface G1F and the other main surface G1G of the glass plate G1 from the optional reference surface are measured.

By obtaining an average of heights at respective measurement points before and after the inversion, influence of self weight is canceled. For example, the height of the main surface G1F is measured as described above before the inversion. After the glass plate G1 is inverted, the height of the other main surface G1G is measured at a position corresponding to the measurement point of the main surface G1F. Similarly, the height of the other one main surface G1G is measured before the inversion. After the glass plate G1 is inverted, the height of the main surface G1F is measured at a position corresponding to the measurement point of the other main surface G1G.

The warpage is measured by a laser displacement gauge, for example.

Regarding the glass 10 according to the present embodiment, surface roughness Ra of the main surface is preferably equal to or smaller than 2 nm. With Ra falling within this range, a nanostructure having a desired shape can be formed on the main surface using an imprint technique and the like, and a desired light guiding characteristic can be obtained. Particularly, in the light guide body, diffuse reflection on an interface is suppressed, and a ghost phenomenon or distortion can be prevented from being caused. This Ra is more preferably equal to or smaller than 1.7 nm, even more preferably equal to or smaller than 1.4 nm, further more preferably equal to or smaller than 1.2 nm, and particularly preferably equal to or smaller than 1 nm. Herein, the surface roughness Ra is arithmetic average roughness defined in JIS B0601 (2001). In this specification, the surface roughness Ra is a value obtained by measuring an area of 10 µm × 10 µm using an atomic force microscope (AFM).

### Method for Manufacturing Glass

The method for manufacturing the glass 10 according to the present embodiment is not particularly limited, and a known method for manufacturing a plate glass can be used. For example, a known method can be used such as a float process, a fusion process, and a roll-out process. However, to suppress deterioration of the transmittance of the glass 10 caused by mixing of impurities, Au and an Au alloy are preferably used as a material of a vessel (crucible) in which raw materials are put at the time of melting the raw materials.

Furthermore, for the glass 10 according to the present embodiment, it is preferable to perform an operation of increasing an amount of moisture in molten glass in a melting process of heating and melting glass raw materials in the melting vessel to obtain the molten glass. The operation of increasing the amount of moisture in the glass is not limited. For example, the operation may be processing of adding water vapor to melting atmosphere, and processing of bubbling gas containing water vapor into a molten material. The operation of increasing the amount of moisture is not essential, but can be performed for the purpose of improving transmittance, improving clarity, and the like.

The glass 10 according to the present embodiment containing an alkali metal oxide such as Li₂O and Na₂O can be chemically strengthened by substituting a Na ion or a K ion for a Li ion, and substituting a K ion for a Na ion. That is, the strength of the optical glass can be improved by chemical strengthening processing.

### (Effects)

As described above, regarding the glass 10 according to the present embodiment, in mole percentage on an oxide basis, Bi₂O₃ > 11.2% is satisfied, that is, the content of Bi₂O₃ is larger than 11.2%. Additionally, the glass 10 contains at least one component selected from the group consisting of TeO₂, TiO₂, WO₃, Nb₂O₅, and Bi₂O₃, and 3.78 ≤ Nb₂O₅/ (TeO₂ + TiO₂ + WO₃ + Nb₂O₅ + Bi₂O₃) × 100 ≤ 19.2 is satisfied, that is, Nb₂O₅/ (TeO₂ + TiO₂ + WO₃ + Nb₂O₅ + Bi₂O₃) ×100 is equal to or larger than 3.78 and equal to or smaller than 19.2. The total content of Fe, Cr, and Ni of the glass 10 is smaller than 4 ppm by mass. Due to such composition, the glass 10 is enabled to have a high refractive index while maintaining a high transmittance with respect to visible light.

Regarding the glass 10, the wavelength λ₇₀ indicating an external transmittance of 70% with a plate thickness of 10 mm is preferably smaller than 450 nm. By causing the wavelength λ₇₀ to fall within this range, the glass 10 has a high transmittance with respect to visible light.

The glass 10 preferably contains P₂O₅ as an essential component. By containing P₂O₅, the glass 10 is enabled to have a high refractive index while maintaining a high transmittance with respect to visible light, and the glass can be stabilized.

Regarding the glass 10, in mole percentage on an oxide basis, TeO₂ > 10.1%, that is, the content of TeO₂ is preferably larger than 10.1%. By causing the content of TeO₂ to fall within this range, the glass 10 is enabled to have a high refractive index while maintaining a high transmittance with respect to visible light.

Regarding the glass 10, in mole percentage on an oxide basis, Bi₂O₃ > 15.0%, that is, the content of Bi₂O₃ is preferably larger than 15.0%. By causing the content of Bi₂O₃ to fall within this range, the glass 10 is enabled to have a high refractive index while maintaining a high transmittance with respect to visible light.

Regarding the glass 10, in mole percentage on an oxide basis, Nb₂O₅ > 15.0% is satisfied, that is, the content of Nb₂O₅ is preferably larger than 15.0%. By causing the content of Nb₂O₅ to fall within this range, the glass 10 is enabled to have a high refractive index while maintaining a high transmittance with respect to visible light.

Regarding the glass 10, the refractive index n_{d} is preferably equal to or larger than 2.0. By causing the refractive index n_{d} to fall within this range, the glass 10 has a high refractive index with respect to visible light.

The glass 10 is preferably used as a light guide plate. The glass 10 having such composition is appropriately used as a light guide plate due to its high refractive index and high transmittance.

The glass 10 that is made as described above is useful for various optical elements, and is particularly preferably used for (1) a light guide body, a filter, a lens, and the like used for a wearable device such as glasses with a projector, an eyeglass-type or goggle-type display, a virtual reality/augmented reality display device, and a virtual image display device, for example, and (2) a lens, cover glass, and the like used for a vehicle-mounted camera and a visual sensor for a robot. The glass 10 is preferably used even for a use such as a vehicle-mounted camera to be subjected to severe environment. Furthermore, the glass 10 is preferably used for a use such as a glass substrate for organic EL, a substrate for a wafer level lens array, a substrate for a lens unit, a lens forming substrate by an etching method, and an optical waveguide.

The glass 10 according to the present embodiment described above has a high refractive index and a high transmittance, has a favorable manufacturing characteristic, and is preferable as optical glass for a wearable device, vehicle-mounted optical glass, and robot-mounted optical glass. An optical component in which an antireflection film is formed on the main surface of the glass 10 is also preferable for a wearable device, a vehicle-mounted optical component, and a robot-mounted optical component, the antireflection film constituted of a dielectric multilayer film including layers the number of which is equal to or larger than 4 and equal to or smaller than 10 in which a low refractive index film such as SiO₂ and a high refractive index film such as TiO₂ are alternately laminated.

### (Examples)

Next, the following describes examples. An implementation aspect may be changed so long as an effect of the invention is exhibited.

In the examples, pieces of glass having different compositions were made. A refractive index and a transmittance were evaluated for each piece of the glass. The following is more detailed description.

Table 1 and Table 2 are tables indicating materials used for glass in the respective examples. Table 1 and Table 2 indicate contents of the materials used for making the glass in mole percentage on an oxide basis for an example 1 to an example 47. An amount of impurities in raw materials in Table 1 and Table 2 indicates an amount of components contained as the raw materials other than components of the materials indicated in Table 1 and Table 2. “Small” means that the amount of impurities is smaller than 3 ppm of the entire raw materials, and “large” means that the amount of impurities is equal to or larger than 3 ppm of the entire raw materials. In Table 1 and Table 2, “Te + Ti + W + Nb + Bi” indicates the total content of TeO₂, TiO₂, WO₃, Nb₂O₅, and Bi₂O₃ of each piece of the glass in mole percentage on an oxide basis. In Table 1 and Table 2, “Nb/(Te + Ti + W + Nb + Bi) × 100” indicates a value obtained by multiplying 100 by a ratio of the content of Nb₂O₅ in mole percentage on an oxide basis to the total content of TeO₂, TiO₂, WO₃, Nb₂O₅, and Bi₂O₃ in mole percentage on an oxide basis. In Table 1 and Table 2, “amount of Fe, Cr, and Ni” indicates the total content of Fe, Cr, and Ni of each piece of the glass. The total content of Fe, Cr, and Ni was measured by ICP mass spectrometry.

TABLE 1

| | Glass Composition | | | | | | | | | | | | | | | | Evaluation | | |
|---|---|---|---|---|---|---|---|---|---|---|---|---|---|---|---|---|---|---|---|
| | P₂O₅(mol%) | TeO₂(mol%) | B₂O₃(mol%) | TiO₂(mol%) | Ta₂O₅(mol%) | WO₃(mol%) | Nb₂O₅(mol%) | Bi₂O₅(mol%) | ZnO(mol%) | SiO₂(mol%) | Al₂O₃(mol%) | Amount of impurities in raw materials | total(mol%) | Te + Ti + W + Nb +Bi (mol%) | Nb(Te + Ti + W + Nb + Bi) × 100 | Amount of Fe, Cr, and Ni | nd | λ₇₀ (nm) | 450 nm internal transmittance (%) |
| Example 1 | 9.6 | 26.5 | 21.5 | 0 | 0 | 0 | 6.7 | 30.4 | 5.4 | 0 | 0 | Small | 100 | 63.5 | 10.5 | < 1 ppm | 2.101 | 437 | 95.8 |
| Example 2 | 10.3 | 27.4 | 20.8 | 0 | 0 | 0 | 7.6 | 29.9 | 4.0 | 0 | 0 | Small | 100 | 64.9 | 11.7 | < 1 ppm | 2.101 | 433 | 96.8 |
| Example 3 | 10.4 | 26.1 | 21.6 | 0 | 0 | 0 | 6.6 | 30.0 | 5.3 | 0 | 0 | Small | 100 | 62.7 | 10.5 | < 1 ppm | 2.091 | 437 | 95.2 |
| Example 4 | 10.3 | 26.1 | 21.8 | 0 | 0 | 0 | 6.6 | 29.9 | 5.3 | 0 | 0 | Small | 100 | 62.6 | 10.5 | < 1 ppm | 2.092 | 432 | 96.7 |
| Example 5 | 10.5 | 18.5 | 26.5 | 0 | 0 | 0 | 1.6 | 37.6 | 5.3 | 0 | 0 | Small | 100 | 57.7 | 2.7 | 2 ppm | 2.093 | 451 | 91.0 |
| Example 6 | 10.5 | 13.5 | 26.5 | 0 | 0 | 0 | 6.6 | 37.6 | 5.3 | 0 | 0 | Large | 100 | 57.7 | 11.4 | 4 ppm | 2.113 | 457 | 90.0 |
| Example 7 | 10.5 | 18.5 | 26.5 | 0 | 0 | 0 | 1.6 | 37.6 | 5.3 | 0 | 0 | Large | 100 | 57.7 | 2.7 | 7 ppm | 2.093 | 465 | 83.0 |
| Example 8 | 10.5 | 18.5 | 26.5 | 0 | 0 | 0 | 1.6 | 37.6 | 5.3 | 0 | 0 | Large | 100 | 57.7 | 2.7 | 5 ppm | 2.093 | 462 | 87.5 |
| Example 9 | 9.6 | 13.7 | 26.6 | 0 | 0 | 5.1 | 1.6 | 38.1 | 5.4 | 0 | 0 | Large | 100 | 58.4 | 2.8 | 7 ppm | 2.107 | 466 | 84.6 |
| Example 10 | 7.6 | 9.3 | 33.5 | 5.6 | 0 | 0 | 0.0 | 43.9 | 0.0 | 0 | 0 | Large | 100 | 58.9 | 0.0 | 8 ppm | 2.127 | 471 | 82.4 |
| Example 11 | 10.5 | 13.5 | 26.5 | 0 | 0 | 0 | 6.6 | 37.6 | 5.3 | 0 | 0 | Small | 100 | 57.7 | 11.4 | < 3 ppm | 2.113 | 444 | 93.8 |
| Example 12 | 11.5 | 16.8 | 21.5 | 0 | 0 | 0 | 6.7 | 38.2 | 5.4 | 0 | 0 | Small | 100 | 61.7 | 10.9 | < 3 ppm | 2.128 | 449 | 91.5 |
| Example 13 | 12.5 | 13.7 | 18.7 | 0 | 0 | 0 | 6.7 | 38.3 | 10.2 | 0 | 0 | Small | 100 | 58.7 | 11.4 | < 3 ppm | 2.127 | 449 | 91.5 |
| Example 14 | 9.6 | 13.7 | 26.6 | 0 | 0 | 5.1 | 6.7 | 33.0 | 5.4 | 0 | 0 | Small | 100 | 58.4 | 11.4 | < 3 ppm | 2.100 | 449 | 91.6 |
| Example 15 | 9.6 | 8.6 | 26.6 | 0 | 0 | 5.1 | 6.7 | 38.1 | 5.4 | 0 | 0 | Small | 100 | 58.4 | 11.4 | < 3 ppm | 2.128 | 449 | 91.8 |
| Example 16 | 9.6 | 8.9 | 26.6 | 0 | 0 | 0 | 6.7 | 38.1 | 10.1 | 0 | 0 | Small | 100 | 53.7 | 12.4 | < 3 ppm | 2.114 | 446 | 92.6 |
| Example 17 | 9.6 | 8.6 | 26.6 | 0 | 0 | 0 | 6.7 | 43.2 | 5.4 | 0 | 0 | Small | 100 | 58.4 | 11.4 | < 3 ppm | 2.145 | 449 | 91.7 |
| Example 18 | 11.5 | 8.6 | 26.6 | 0 | 0 | 0 | 6.7 | 41.2 | 5.4 | 0 | 0 | Small | 100 | 56.6 | 11.8 | < 3 ppm | 2.119 | 447 | 92.3 |
| Example 19 | 9.6 | 23.8 | 21.5 | 0 | 0 | 0 | 6.7 | 33.0 | 5.4 | 0 | 0 | Small | 100 | 63.5 | 10.5 | < 3 ppm | 2.117 | 445 | 93.1 |
| Example 20 | 9.6 | 19.0 | 21.5 | 0 | 0 | 0 | 6.7 | 33.0 | 10.1 | 0 | 0 | Small | 100 | 58.8 | 11.4 | < 3 ppm | 2.112 | 444 | 93.6 |
| Example 21 | 9.6 | 19.0 | 22.2 | 0 | 0 | 0 | 8.6 | 30.4 | 10.1 | 0 | 0 | Small | 100 | 58.0 | 14.8 | < 3 ppm | 2.102 | 445 | 93.3 |
| Example 22 | 9.6 | 28.5 | 19.9 | 0 | 0 | 0 | 8.2 | 28.4 | 5.4 | 0 | 0 | Small | 100 | 65.1 | 12.6 | < 3 ppm | 2.105 | 447 | 92.5 |
| Example 23 | 10.3 | 19.0 | 21.5 | 0 | 0 | 0 | 8.6 | 30.4 | 10.1 | 0 | 0 | Small | 100 | 58.1 | 14.8 | < 3 ppm | 2.099 | 446 | 92.4 |
| Example 24 | 10.3 | 19.0 | 21.5 | 0 | 0 | 0 | 10.7 | 28.4 | 10.1 | 0 | 0 | Small | 100 | 58.1 | 18.3 | < 3 ppm | 2.095 | 447 | 92.1 |
| Example 25 | 10.3 | 19.0 | 21.5 | 0 | 0.5 | 0 | 8.6 | 30.4 | 9.6 | 0 | 0 | Small | 100 | 58.1 | 14.8 | < 3 ppm | 2.101 | 449 | 91.8 |

TABLE 2

| | Glass Composition | | | | | | | | | | | | | | | | Evaluation | | |
|---|---|---|---|---|---|---|---|---|---|---|---|---|---|---|---|---|---|---|---|
| | P₂O₅(mol%) | TeO₂(mol%) | B₂O₃(mol%) | TiO₂(mol%) | Ta₂O₅(mol%) | WO₃(mol%) | Nb₂O₅(mol%) | Bi₂O₃(mol%) | ZnO(mol%) | SiO₂(mol%) | Al₂O₃(mol%) | Amount of impurities in raw materials | Total(mol%) | Te + Ti + W + Nb + B (mol%) | Nb(Te + Ti + W + Nb + Bi) × 100 | Amount of Fe, Cr, and Ni | nd | λ₇₀ (nm) | 450 nm internal transmittance (%) |
| Example 26 | 9.6 | 21.5 | 22.2 | 0 | 0 | 0 | 6.2 | 31.9 | 8.6 | 0 | 0 | Small | 100 | 59.6 | 10.4 | < 3 ppm | 2.101 | 445 | 93.5 |
| Example 27 | 9.6 | 23.9 | 22.2 | 0 | 0 | 0 | 3.7 | 33.9 | 6.6 | 0 | 0 | Small | 100 | 61.6 | 6.1 | < 3 ppm | 2.105 | 443 | 94.1 |
| Example 28 | 9.6 | 19.0 | 22.2 | 0 | 0 | 0 | 6.7 | 32.4 | 10.0 | 0 | 0 | Small | 100 | 58.1 | 11.5 | < 3 ppm | 2.104 | 443 | 94.0 |
| Example 29 | 9.6 | 19.0 | 22.2 | 0 | 0 | 0 | 4.7 | 34.4 | 10.0 | 0 | 0 | Small | 100 | 58.1 | 8.0 | < 3 ppm | 2.107 | 446 | 93.5 |
| Example 30 | 9.6 | 23.9 | 21.5 | 0 | 0 | 0 | 6.7 | 30.9 | 7.4 | 0 | 0 | Small | 100 | 61.5 | 10.9 | < 3 ppm | 2.103 | 442 | 94.1 |
| Example 31 | 9.6 | 26.5 | 21.5 | 0 | 0 | 0 | 5.7 | 31.4 | 5.4 | 0 | 0 | Small | 100 | 63.5 | 8.9 | < 3 ppm | 2.105 | 443 | 94.2 |
| Example 32 | 9.6 | 19.0 | 22.2 | 0 | 0 | 2.0 | 6.7 | 30.4 | 10.0 | 0 | 0 | Small | 100 | 58.1 | 11.5 | < 3 ppm | 2.097 | 446 | 93.1 |
| Example 33 | 10.8 | 28.9 | 19.8 | 0 | 0 | 0 | 7.6 | 29.9 | 3.0 | 0 | 0 | Small | 100 | 66.4 | 11.4 | < 3 ppm | 2.102 | 439 | 95.3 |
| Example 34 | 10.3 | 27.4 | 16.8 | 0 | 0 | 0 | 7.6 | 29.9 | 8.0 | 0 | 0 | Small | 100 | 64.9 | 11.7 | < 3 ppm | 2.116 | 446 | 93.3 |
| Example 35 | 11.3 | 27.4 | 16.8 | 0 | 0 | 0 | 6.6 | 29.9 | 8.0 | 0 | 0 | Small | 100 | 63.9 | 10.3 | < 3 ppm | 2.103 | 439 | 95.2 |
| Example 36 | 10.3 | 27.4 | 16.8 | 0 | 0 | 0 | 5.6 | 29.9 | 10.0 | 0 | 0 | Small | 100 | 62.9 | 8.9 | < 3 ppm | 2.106 | 439 | 95.0 |
| Example 37 | 8.3 | 27.4 | 19.8 | 0 | 0 | 0 | 4.6 | 29.9 | 10.0 | 0 | 0 | Small | 100 | 61.9 | 7.4 | < 3 ppm | 2.106 | 441 | 94.9 |
| Example 38 | 10.3 | 27.4 | 17.8 | 0 | 0 | 0 | 5.6 | 29.9 | 9.0 | 0 | 0 | Small | 100 | 62.9 | 8.9 | < 3 ppm | 2.103 | 440 | 95.0 |
| Example 39 | 12.3 | 27.9 | 15.3 | 0 | 0 | 0 | 6.6 | 29.9 | 8.0 | 0 | 0 | Small | 100 | 64.4 | 10.2 | < 3 ppm | 2.101 | 437 | 95.4 |
| Example 40 | 10.3 | 27.4 | 18.8 | 0 | 0 | 0 | 7.6 | 29.9 | 6.0 | 0 | 0 | Small | 100 | 64.9 | 11.7 | < 3 ppm | 2.109 | 442 | 94.7 |
| Example 41 | 10.3 | 27.4 | 18.8 | 0 | 0 | 0 | 6.6 | 29.9 | 7.0 | 0 | 0 | Small | 100 | 63.9 | 10.3 | < 3 ppm | 2.104 | 437 | 95.7 |
| Example 42 | 10.3 | 27.4 | 17.3 | 0 | 0 | 0 | 5.1 | 29.9 | 10.0 | 0 | 0 | Small | 100 | 62.4 | 8.1 | < 3 ppm | 2.102 | 439 | 95.5 |
| Example 43 | 10.3 | 28.2 | 17.0 | 0 | 0 | 0 | 4.6 | 29.9 | 10.0 | 0 | 0 | Small | 100 | 62.7 | 7.3 | < 3 ppm | 2.101 | 438 | 95.5 |
| Example 44 | 0.0 | 21.5 | 36.1 | 0 | 0 | 0 | 3.0 | 30.4 | 9.0 | 0 | 0 | Small | 100 | 54.8 | 5.5 | < 3 ppm | 2.099 | 443 | 94.6 |
| Example 45 | 9.5 | 26.2 | 21.3 | 0 | 0 | 0 | 5.6 | 31.1 | 5.3 | 1.0 | 0 | Small | 100 | 62.9 | 8.9 | < 3 ppm | 2.097 | 437 | 95.5 |
| Example 46 | 9.4 | 25.7 | 20.9 | 0 | 0 | 0 | 5.5 | 30.5 | 5.2 | 3.0 | 0 | Small | 100 | 61.7 | 8.9 | < 3 ppm | 2.088 | 436 | 95.9 |
| Example 47 | 9.5 | 26.2 | 21.3 | 0 | 0 | 0 | 5.6 | 31.1 | 5.3 | 0 | 1.0 | Small | 100 | 62.9 | 8.9 | < 3 ppm | 2.097 | 437 | 95.5 |

In the examples, pieces of glass respectively having thicknesses of 10 mm and 1 mm were manufactured with compositions described in the respective examples in Table 1 and Table 2. The pieces of glass manufactured as described above were used as samples to perform evaluation. Specifically, raw materials with compositions indicated in Table 1 and Table 2 were uniformly mixed, and molten for two hours in a gold crucible at 950° C. to be uniform molten glass. Next, the molten glass was poured into a mold made of carbon having a size of length × width × height = length 60 mm × width 50 mm × height 30 mm. Thereafter, the molten glass was held for one hour at 430° C., and cooled to a room temperature at a temperature drop rate of about 1° C./minute to obtain a glass block. Next, the glass block was cut to have a size of length × width = 30 mm × 30 mm using a cutting machine (compact cutting machine manufactured by MARUTO INSTRUMENT CO., LTD.), and adjustment of a plate thickness and surface polishing were performed thereon using a grinder (SGM-6301 manufactured by Shuwa Industry co., ltd.) and a single-side polishing machine (EJ-380IN manufactured by Engis Japan Corporation) to manufacture glass plates each having a size of length × width = 30 mm × 30 mm and having plate thicknesses of 10 mm and 1 mm.

### Evaluation

For the pieces of glass in the respective examples, a refractive index and a transmittance with respect to visible light were evaluated. In evaluation of the refractive index, the refractive index n_{d} at a d line of helium (wavelength of 587.6 nm) was measured for each piece of the glass. The refractive index n_{d} was measured by using KPR-2000 manufactured by Kalnew. In evaluation of the refractive index, the refractive index n_{d} equal to or larger than 2.0 was accepted, and the refractive index n_{d} smaller than 2.0 was rejected.

In evaluation of the transmittance, the wavelength λ₇₀ indicating an external transmittance of 70% with a plate thickness of 10 mm was measured for each piece of the glass. The wavelength λ₇₀ was measured by using U-4100 manufactured by Hitachi High-Tech Corporation. In evaluation of the transmittance, the wavelength λ₇₀ smaller than 450 nm was accepted, and the wavelength λ₇₀ equal to or larger than 450 nm was rejected.

### Evaluation Results

As indicated in Table 1 and Table 2, it can be found that, in the example 1 to the example 4, and the example 11 to the example 47 as the examples, both of the refractive index n_{d} and the wavelength λ₇₀ are accepted, and a high refractive index and a high transmittance are achieved. It can also be found that, in the examples 5 to 10 as comparative examples, the wavelength λ₇₀ is rejected, and a high transmittance cannot be achieved.

As optional evaluation of the transmittance, an internal transmittance of light at a wavelength of 450 nm with a plate thickness of 10 mm was also measured. The internal transmittance was measured by using U-4100 manufactured by Hitachi High-Tech Corporation. In the optional evaluation, the internal transmittance of light at a wavelength of 450 nm equal to or larger than 91.5% was assumed to be preferred. As indicated in Table 1 and Table 2, it can be found that preferable evaluation results are obtained in the examples 1 to 4 and the examples 11 to 47, and the transmittance of visible light can be achieved more preferably.

The embodiment of the present invention has been described above, but the embodiment is not limited thereto. The constituent elements described above include a constituent element that is easily conceivable by those skilled in the art, substantially the same constituent element, and what is called an equivalent. Furthermore, the constituent elements described above can be appropriately combined. In addition, the constituent elements can be variously omitted, replaced, or modified without departing from the gist of the embodiment described above.

### REFERENCE SIGNS LIST

GLASS

1. Glass containing:
at least one component selected from the group consisting of TeO₂, TiO₂, WO₃, Nb₂O₅, and Bi₂O₃, where Bi₂O₃ > 11.2% is satisfied, in mole percentage on an oxide basis, wherein
3.78 ≤ Nb₂O₅/ (TeO₂ + TiO₂ + WO₃ + Nb₂O₅ + Bi₂O₃) × 100 ≤ 19.2 is satisfied, and
a total content of Fe, Cr, and Ni is smaller than 4 ppm by mass.

2. The glass according to claim 1, wherein a wavelength λ₇₀ indicating an external transmittance of 70% with a plate thickness of 10 mm is smaller than 450 nm.

3. The glass according to claim 1, containing P₂O₅ as an essential component.

4. The glass according to claim 1, wherein TeO₂ > 10.1% is satisfied in mole percentage on an oxide basis.

5. The glass according to claim 1, wherein Bi₂O₃ > 15.0% is satisfied in mole percentage on an oxide basis.

6. The glass according to claim 1, wherein Nb₂O₅ < 15.0% is satisfied in mole percentage on an oxide basis.

7. The glass according to claim 1, wherein a refractive index n_{d} is equal to or larger than 2.0.

8. The glass according to claim 1, used as a light guide plate.
